(19) United States
(12) Patent Application Publication
(10) Pub. No.: US 2022/0121195 A1
(43) Pub. Date: Apr. 21, 2022

(54) Predictive Maintenance Tool Based on Digital Model

(71) Applicant: WestRock Packaging Systems, LLC, Atlanta, GA (US)

(72) Inventors: Jean-Christophe Bonnain, Châteauroux (FR); Frederic Limousin, Le Poinconnet (FR); Barbara Luche, Vouillon (FR); Francis Bennevault, Chateauroux (FR)

(21) Appl. No.: 17/421,936

(22) PCT Filed: Jan. 8, 2020
(86) PCT No.: PCT/US2020/012719

§ 371 Date: Jul. 9, 2021

Related U.S. Application Data
(60) Provisional application No. 62/790,182, filed on Jan. 9, 2019.

(51) Int. Cl. G05B 23/02

(52) U.S. Cl. CPC G05B 23/0283; G05B 23/0235

(57) ABSTRACT

An exemplary predictive maintenance method comprises a step of generating a default signature for a machine based on simulations of the machine, a step of comparing the default signature to readings of the machine in operation, a step of determining whether a default will occur to the machine as it continues to operate, and a step of controlling the machine so that it operates in a normal mode or avoids the default.

### FIELD OF THE INVENTION

This invention relates to systems that enable predictive maintenance of machines, such as tools and other equipment, based on predicting and controlling the real-world operation of the machines based on digital models of the same.

### BACKGROUND OF THE INVENTION

Manufacturing and other forms of machinery may operate in at least two modes: (i) a normal mode of operation and (ii) a default mode or default condition operation. The normal mode of operation is the expected manner in which the machine is meant to operate. The default mode of operation is one in which the machine may be considered to act unexpectedly to its normal mode of operation or one in which the machine may act in a way that accelerates failure or damage to the machine, its user, the object(s) on which it is operating, or a combination of the same.

In known machine operation monitoring techniques, machine default modes may be detected using sensors (e.g., accelerometers, gauges, meters) during intervals when the machine is supposed to be operating in its normal mode. Several drawbacks exist to this type of technique, including, the inability to preempt the default mode until it takes place or using numerous sensors on the machine at all times. Another drawback is the inability of the system to preempt other default modes that the sensors may not have picked up yet. Consequently, these known machine monitoring techniques may only identify when the default mode is taking place, but fails to provide a way to avoid or preempt it during normal mode.

There is also a need for repository of data recorded of machine normal modes of operation using sources of recorded information, including, for example, the Internet of Things (“IoT”), and from such a repository, an exemplary system may access stored normal modes of operation for machines and/or their components and use the same to compare to present conditions and thereby determine, preempt, and rectify machine defaults.

There is also a need for a repository of data recorded of machine default modes of operation using sources of recorded information, including, for example, the IoT, and from such a repository, an exemplary system may access stored default modes of operation for machines and/or their components and use the same to compare to normal mode of operation conditions and thereby determine, preempt, and rectify machine defaults.

### BRIEF DESCRIPTION OF THE DRAWINGS

FIG. 1A is an exemplary embodiment of a machine and data acquisition and data representation of operation of same.

FIG. 1B is an exemplary embodiment of a simulation of the machine of FIG. 1A, including data acquisition and data representation of operation of same.

FIG. 2A is an exemplary embodiment of a comparison between data acquired from a machine and its simulation.

FIG. 2B is another exemplary embodiment of a comparison between data acquired from a machine and its simulation.

FIG. 3A is an exemplary embodiment of an exemplary default signature generation.

FIG. 3B is an exemplary embodiment of a comparison between data acquired from an exemplary machine and an exemplary default signature.

FIG. 4 is an exemplary embodiment of a predictive maintenance method.

In the drawings like characters of reference indicate corresponding parts in the different figures. The drawing figures, elements and other depictions should be understood as being interchangeable and may be combined, modified, and/or optimized in any like manner in accordance with the disclosures and objectives recited herein as would be understood to those skilled in the art.

### DETAILED DESCRIPTION

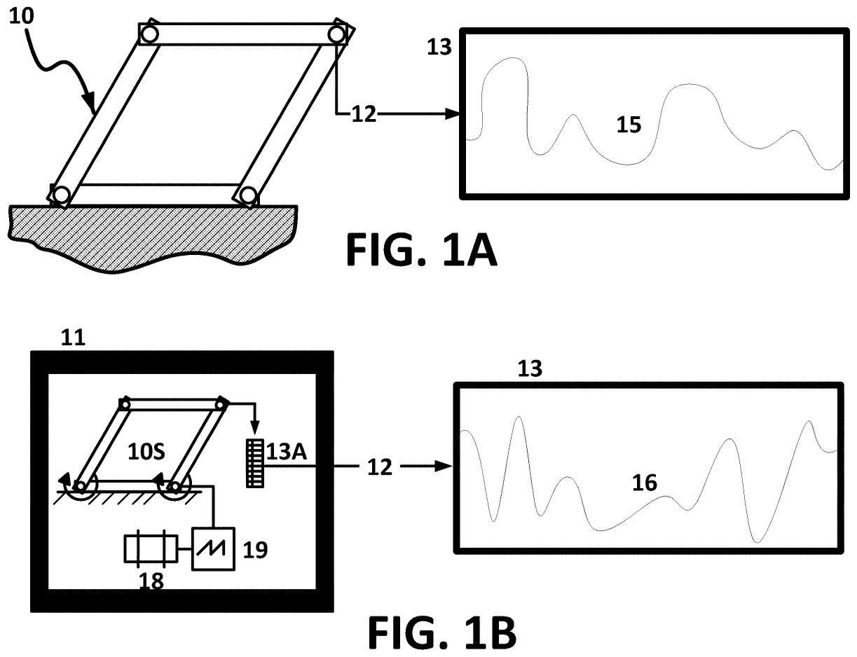

According to the exemplary embodiment of FIG. 1A, an exemplary machine 10 may be operated under normal conditions and its operation signature 15 recorded via a data acquisition utility 12 and rendered in a digital format 13 for storage/use/analysis of same. In an exemplary embodiment, the operation signature 15 may be for one component of machine 10 or for the entirety of machine 10. Additionally, operation signature 15 may be acquired using sensors, meters, gauges, accelerometers, and other data acquisition techniques known to those skilled in the art. Those skilled in the art may also understand that the operation signature 15 may also be stored in an exemplary predictive maintenance system on a cloud (e.g., IoT) or other database for reference. An exemplary operation signature 15 may be produced over a period of time or recorded in intervals for later discrimination by the system (e.g., for torque-producing mechanisms, there may be a normal mode of operation at 100% load, normal mode of operation at 50% load, etc.). According to the disclosures herein, a “normal” mode of operation may also be referred to as a “nominal” mode of operation of the machine 10.

With reference to FIG. 1B, an exemplary machine simulation 10S may be operated under normal conditions 15 and/or operated so as to generate a default signature 16. In an exemplary embodiment, a digital rendition of machine simulation 10S may be made using known computer aided design (“CAD”) software packages known to those skilled in the art (e.g., SolidWorks, CATIA, PTC's CREO software tool, Siemens' NX software tool, and Autodesk's Inventor software tool). Using a known CAD system 11, a default signature 16 for machine simulation 10S may be generated by operating the machine simulation 10S using a simulated input source of energy 18, a simulated load, stress, force, or other imposition of a condition 19 (e.g., simulated torque on a joint, simulated pressure on a part), and, with those inputs 18 and 19, produce a simulated output 13A which through known data acquisition utilities 12 may be rendered graphically as a default signature 16 in a digital format 13 for storage/use/analysis of same. In an exemplary embodiment, the default signature 16 may be for one component of simulation machine 10S or for the entirety of simulated machine 10S. Additionally, default signature 16 may also take into consideration prior acquisition of default behaviors of a machine 10 previously-acquired using sensors, meters, gauges, accelerometers, and other data acquisition techniques known to those skilled in the art. Those skilled in the art may also understand that the default signature 16 may also be stored in an exemplary predictive maintenance system on a cloud (e.g., IoT) or other database for reference. An exemplary default signature 16 may be produced over a period of time or recorded in intervals for later discrimination by the system (e.g., for torque-producing mechanisms, there may be a normal mode of operation at 100% load, normal mode of operation at 50% load, etc.).

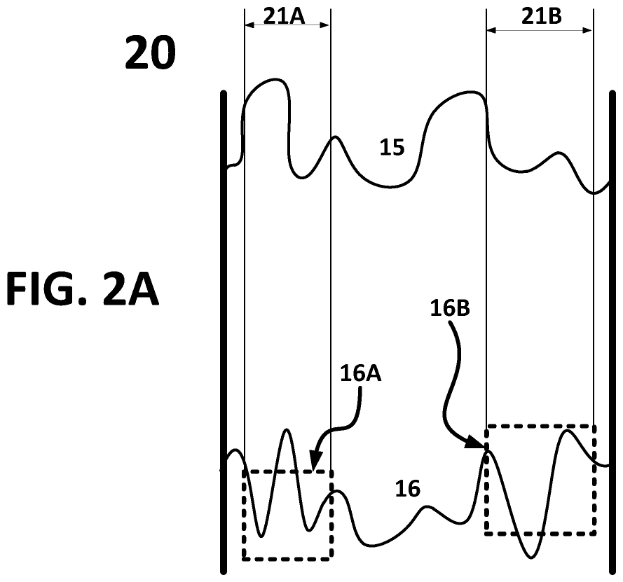

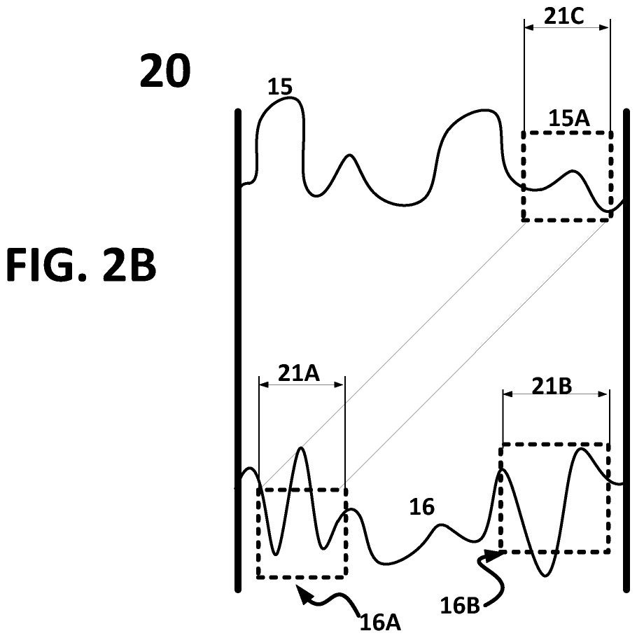

With reference to FIG. 2A, an exemplary embodiment of the predictive maintenance method 20 may include a comparison between the normal operation signature 15 received from a machine 10 (either received in real time or forecasted based on prior-acquired normal data) and the default signature 16 of an exemplary simulation of machine 10 (e.g., machine 10S). In an exemplary embodiment, an exemplary predictive maintenance method 20 may select certain portions of the default signature 16 (e.g., default portions 16A and 16B) and compare these portions to the portions of the normal operation signature 15 as it is received via the data acquisition utilities 12. An exemplary predictive maintenance method may identify default signature portions 16A and 16B as occurring during exemplary time intervals 21A and 21B, respectively. However, an exemplary predictive maintenance method may include checks of operational signature 15 for default portions 16A and 16B at time intervals before, during, or after intervals 21A and/or 21B, as may be shown in FIG. 2B. In an exemplary embodiment of a predictive maintenance method 20 as illustratively provided for in FIG. 2B, an exemplary default portion 16A occurring over a time interval of 21A may be used to detect and/or control the occurrence of a default at portion 15A of operation mode signature 15 over a time interval of 21C. In an exemplary embodiment, an exemplary system 20 may not only use known data comparison techniques and filters to analyze the signature data between the normal operation mode signature 15 and default signature 16 (as would be understood to those skilled in the art and will be discussed in further detail below), but may also compare relative time frames (21A versus 21C) to more quickly determine whether a default condition is more likely to take place. While default signatures 16 may be shown as curves of points, it is also contemplated that where default is a maximum tolerance or a failure point, then a threshold line or a single point for the default signature 16 may be used.

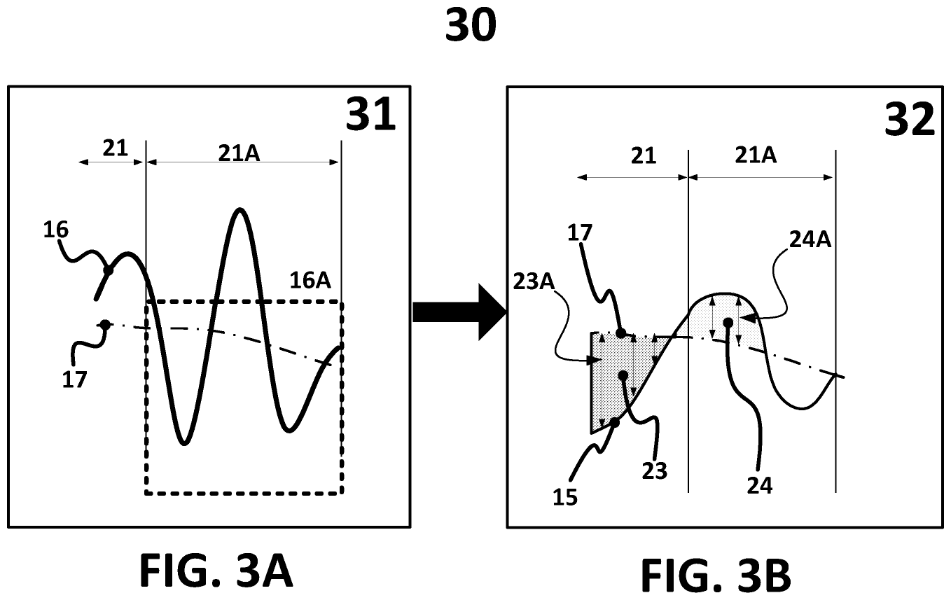

According to another exemplary embodiment of a predictive maintenance method 30 as illustratively provided for in FIG. 3A, an exemplary data compilation step 31 may include generating a trend line or regression analysis of default signature 16 which may yield a characteristic default curve 17 representing the default signature 16 across various time intervals (e.g., time interval 21 and 21A). Other types of statistical methodologies known to those skilled in the art may be utilized to render the characteristic default curve 17. Alternatively, characteristic default curve 17 may be comprised of repeated sections of default signature 16 to allow an exemplary predictive maintenance method 30 to repeatedly check for a specific portion of the default signature 16 during the entire duration of normal mode of operation 15.

According to another exemplary embodiment of a predictive maintenance method 30 as illustratively provided for in FIG. 3B, an exemplary data comparison step 32 may involve calculating, measuring, and otherwise determining whether deviations between a normal mode of operation 15 of machine 10 and characteristic default signature 17 may indicate the future occurrence of a default condition. While characteristic default signature 17 may be illustratively provided in FIG. 3B, one may also calculate, measure, and otherwise determine whether deviations between a normal mode of operation 15 of machine 10 and default signature 16 may indicate the future occurrence of a default condition.

As illustratively provided for in FIG. 3B, deviations 23 and 24 between machine 10 operation 15 and default signature 16 and/or its characteristic curve 17 may be compared to threshold values or tolerances previously recorded in the memory of the system 30. Alternatively, these deviations 23 and 24 may be generated based on data acquired from the IoT or from prior deviation analyses stored in system 30 memory. Permissible deviations 23 may be dependent on the time interval of the default operation (e.g. time interval 21 versus time interval 21A) or the portion of the machine operation 15 received.

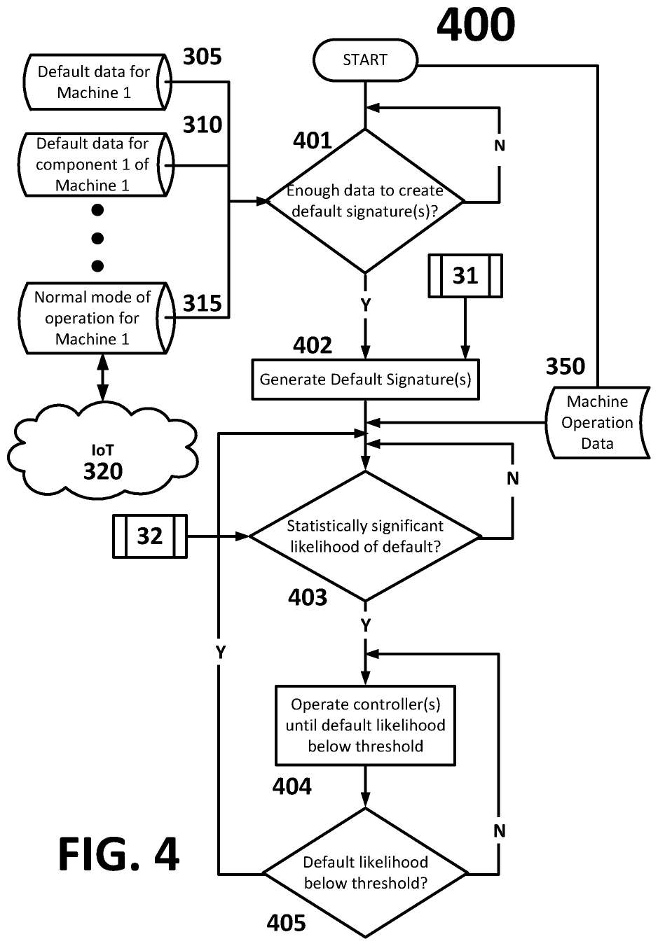

In an exemplary embodiment of a predictive maintenance method 40 illustratively provided in FIG. 4, a default signature determination step 401 may include determining whether sufficient data exists to create a default signature. For example, step 401 may look to default signatures stored in databases 305, 310, and IoT 320, where it may be indexed for selection. In some embodiments, step 401 may determine whether the default signatures found in the various databases can be used individually or in combination to render the default signature needed for the remainder of method 40. An exemplary default signature decision step 401 may also include review of stored normal operation signatures, e.g., stored in database 315, IoT 320, to compare to other signatures to determine other deviations that may qualify as defaults. Where sufficient information exists to determine default signatures for the machine 10, the method 40 may thereafter generate the default signature(s) for use in the method in step 402. An exemplary default signature generation step 402 may include characteristic curve generation for defaults as illustratively provided in step 31 of FIG. 3.

Simultaneously or at another time, the predictive maintenance method 40 may receive real-time data from exemplary machine 10 via external database 350. Using the operation data of an exemplary machine 10, the predictive maintenance method may then assess, via decision step 403, whether the likelihood of a default will require preemption or rectification to the operation of exemplary machine 10. In an exemplary embodiment, the likelihood of a default may be based on deviations (e.g., deviations 23 and 24 shown in step 32 of FIG. 3) from default signature curve(s) 16 and/or characteristic default curve(s) 17. The likelihood of default may be on the basis of an exemplary machine 10 in total or may be on a machine 10 component-by-component basis. The statistical likelihood of a default as determined in step 403 may be a function of an exemplary machine 10 component's criticality to machine 10 operation (e.g., weighted scoring of default signatures), information on the component's frequency of default from a database (e.g., IoT 320), and/or information on the time to correct/control such default from past predictive maintenance method use, which may be stored, for example in a database or obtained via IoT 320.

In an alternative embodiment of predictive maintenance method 40, once a default signature 16 has been generated in step 402, the system may forecast when the normal mode of operation of an exemplary machine 10 would expect to have said default based on the timing of the default in signature 16. For example, a default signature 16 may be characterized by one or more points, markers, trend lines, etc., to generate a characteristic default 17. According to this alternative embodiment, the system may search the normal mode of operation signature 15 to determine the greatest correspondence between the characteristic default 17 and the normal mode of operation signature 15 and preempt the default at that specific time.

In further accordance with the exemplary embodiment of predictive maintenance method 40, upon determining default is likely to occur in the operation of an exemplary machine 10, the method 40 may control the exemplary machine 10 so as to lower the likelihood of default occurrence and/or eliminate possibility of default to extent possible (exemplary step 405). Control systems for machine operation and control are known to those skilled in the art, such as MathWorks Simulink, and may include one or more of the following: PID algorithms, fuzzy logic, receive/transmit and PB filters, and other operators found in conventional control system software packages and instruments (e.g., Simulink library).

This present invention disclosure and exemplary embodiments are meant for the purpose of illustration and description. The invention is not intended to be limited to the details shown. Rather, various modifications in the illustrative and descriptive details, and embodiments may be made by someone skilled in the art. These modifications may be made in the details within the scope and range of equivalents of the claims without departing from the scope and spirit of the several interrelated embodiments of the present invention.

What is claimed is:

1. A predictive maintenance method, comprising the steps of:
generating a default signature for a machine based on simulations of the machine;
comparing the default signature to readings of the machine in operation;
determining whether a default will occur to the machine as it continues to operate; and
controlling the machine so that it operates in a normal mode or avoids the default.

2. The predictive maintenance method claim 1, wherein the step of generating the default signature includes generating the default signature for a component of the machine based on simulations of the component of the machine.

3. The predictive maintenance method claim 1, wherein the step of comparing includes comparing to a representation of the default signature.

4. The predictive maintenance method claim 3, wherein the representation of the default signature includes a trend line representing the default signature.

5. The predictive maintenance method claim 3, wherein the representation of the default signature includes a threshold level.

6. The predictive maintenance method claim 3, wherein the representation of the default signature includes a single maximum value.

7. The predictive maintenance method claim 2, wherein the step of comparing includes comparing to a representation of the default signature.

8. The predictive maintenance method claim 7, wherein the representation of the default signature includes a trend line representing the default signature.

9. The predictive maintenance method claim 7, wherein the representation of the default signature includes a threshold level.

10. The predictive maintenance method claim 7, wherein the representation of the default signature includes a single maximum value.

11. The predictive maintenance method claim 1, wherein the step of determining whether a default will occur includes comparing the default signature to a normal signature.

12. The predictive maintenance method claim 2, wherein the step of determining whether a default will occur includes comparing the default signature to a normal signature.

13. The predictive maintenance method claim 3, wherein the step of determining whether a default will occur includes comparing the default signature to a normal signature.

14. The predictive maintenance method claim 4, wherein the step of determining whether a default will occur includes comparing the default signature to a normal signature.

15. The predictive maintenance method claim 5, wherein the step of determining whether a default will occur includes comparing the default signature to a normal signature.

16. The predictive maintenance method claim 6, wherein the step of determining whether a default will occur includes comparing the default signature to a normal signature.

17. The predictive maintenance method claim 7, wherein the step of determining whether a default will occur includes comparing the default signature to a normal signature.

18. The predictive maintenance method claim 8, wherein the step of determining whether a default will occur includes comparing the default signature to a normal signature.

19. The predictive maintenance method claim 9, wherein the step of determining whether a default will occur includes comparing the default signature to a normal signature.

20. The predictive maintenance method claim 10, wherein the step of determining whether a default will occur includes comparing the default signature to a normal signature.
